(19) United States
(12) Patent Application Publication
(10) Pub. No.: US 2016/0334772 A1
(43) Pub. Date: Nov. 17, 2016

(54) APPARATUS AND METHOD FOR CORRELATING DATA

(71) Applicant: NOKIA TECHNOLOGIES OY, Espoo (FI)

(72) Inventors: David NGUYEN, Santa Clara, CA (US); Praveen KRISHNAN, Sunnyvale, CA (US)

(21) Appl. No.: 15/110,832

(22) PCT Filed: Jan. 31, 2014
(86) PCT No.: PCT/US14/14326

§ 371 Date: Jul. 11, 2016

(51) Int. Cl. G05B 19/048; F24F 11/00; G06F 17/30; H04L 12/28; G05B 11/01; G05B 19/042; H04L 29/08

(52) U.S. Cl. CPC G05B 19/048; G05B 19/042; F24F 11/0034; H04L 67/125; H04L 12/2818; G05B 11/01; G06F 17/30864; G05B 2219/2614

(57) ABSTRACT

Mechanisms are described for correlating environmental data (such as data regarding object settings) with performance data (such as data regarding a result of a predefined activity). The performance data may be analyzed to determine whether the result of the predefined activity can be considered a predetermined aspirational result (e.g., a result that the user desires to achieve), such that the user would want to obtain the same result the next time the user performs the same activity. In the event the result is a predetermined aspirational result, the object or objects that contributed to the predetermined aspirational result may be identified, such as by correlating the performance data with the environmental data to determine the relationship between the two. The object settings for the identified objects may also be identified.

### TECHNOLOGICAL FIELD

Example embodiments of the present invention relate generally to managing and correlating data, such as data gathered by objects that are accessible via the Internet of Things.

### BACKGROUND

In the modern age of electronics, numerous aspects of a person's environment are governed by electronic devices and devices that are electronically controlled or set. From sound systems to alarm systems, lighting systems to heating and cooling systems, people are able to adjust various environmental parameters to enhance their comfort with the push of a button or the click of a switch. At the same time, a person's ability to accomplish certain tasks can be heavily influenced by his or her environment. Activities such as sleeping, exercising, thinking, etc. can be heavily influenced by a person's environment.

### BRIEF SUMMARY OF EXAMPLE EMBODIMENTS

Accordingly, it may be desirable to provide tools that allow users to easily manage electronic devices and objects that play a role in creating the person's environment by correlating data regarding various object settings with data indicative of the results the person achieves in a particular environmental scenario. In this way, embodiments of the invention described herein can determine which objects allow the user to achieve the best results for a particular activity and/or which settings should be used to achieve those results, thereby allowing the user to achieve optimal results in a repeated and consistent manner.

In some embodiments, an apparatus is provided for correlating environmental data with performance data to achieve a predetermined aspirational result for a predetermined activity. The apparatus may include at least one processor and at least one memory including computer program code. The at least one memory and the computer program code may be configured to, with the processor, cause the apparatus to at least receive environmental data regarding object settings for a plurality of objects, receive performance data regarding a result of a predefined activity, determine whether the result is a predetermined aspirational result based at least on the performance data received, and in an instance in which the result is the predetermined aspirational result, identify at least one of the plurality of objects as contributing to the predetermined aspirational result based at least on the environmental data received. The object settings may comprise an operational state of an object or an indication of presence of the object.

In an instance in which the result is the predetermined aspirational result, the at least one memory and the computer program code may be configured to, with the processor, cause the apparatus to determine the object setting for at least one of the objects identified based at least on the environmental data. In some embodiments, the at least one memory and the computer program code may be configured to, with the processor, cause the apparatus to cause the at least one object identified to be set at the respective object setting determined.

Furthermore, the at least one memory and the computer program code may be configured to, with the processor, cause the apparatus to provide for storage of the environmental data and the performance data received and to determine a relationship between the object settings and the result of the predefined activity based on analysis of the environmental data and the performance data over a period of time. In an instance in which the result is not the predetermined aspirational result, the at least one memory and the computer program code may be configured to, with the processor, cause the apparatus to determine a future setting of at least one of the objects based on the relationship determined in an attempt to achieve the predetermined aspirational result. The at least one memory and the computer program code may be configured to, with the processor, cause the apparatus to provide for adjustment of a setting of the at least one of the objects to the setting determined. In some cases, the performance data may be received from at least one performance sensor.

In other embodiments, a method and a computer program product are provided for receiving environmental data regarding object settings for a plurality of objects; receiving performance data regarding a result of a predefined activity; determining whether the result is a predetermined aspirational result based at least on the performance data received; and in an instance in which the result is the predetermined aspirational result, identifying at least one of the plurality of objects as contributing to the predetermined aspirational result based at least on the environmental data received. The object settings may comprise an operational state of an object or an indication of presence of the object.

In an instance in which the result is the predetermined aspirational result, the method and computer program product may further comprise determining the object setting for at least one of the objects identified based at least on the environmental data. Moreover, the method and computer program product may further comprise causing the at least one object identified to be set at the respective object setting determined.

In some embodiments, the method and computer program product may further comprise providing for storage of the environmental data and the performance data received and determining a relationship between the object settings and the result of the predefined activity based on analysis of the environmental data and the performance data over a period of time. In an instance in which the result is not the predetermined aspirational result, the method and computer program code may further comprise determining a future setting of at least one of the objects based on the relationship determined in an attempt to achieve the predetermined aspirational result. The method and computer program code may further comprise providing for adjustment of a setting of the at least one of the objects to the setting determined. In some cases, the performance data may be received from at least one performance sensor.

In still other embodiments, an apparatus is provided for correlating environmental data with performance data to achieve a predetermined aspirational result for a predetermined activity. The apparatus may include means for receiving environmental data regarding object settings for a plurality of objects; means for receiving performance data regarding a result of a predefined activity; means for determining whether the result is a predetermined aspirational result based at least on the performance data received; and in an instance in which the result is the predetermined aspirational result, means for identifying at least one of the plurality of objects as contributing to the predetermined aspirational result based at least on the environmental data received. The object settings may comprise an operational state of an object or an indication of presence of the object.

In an instance in which the result is the predetermined aspirational result, the apparatus may further comprise means for determining the object setting for at least one of the objects identified based at least on the environmental data. Moreover, the apparatus may further comprise means for providing for storage of the environmental data and the performance data received and means for determining a relationship between the object settings and the result of the predefined activity based on analysis of the environmental data and the performance data over a period of time. In an instance in which the result is not the predetermined aspirational result, the apparatus may further comprise means for determining a future setting of at least one of the objects based on the relationship determined in an attempt to achieve the predetermined aspirational result.

### BRIEF DESCRIPTION OF THE SEVERAL VIEWS OF THE DRAWING(S)

Having thus described example embodiments of the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for correlating environmental data with performance data according to an example embodiment of the present invention;

FIG. 3 illustrates a system for correlating environmental data with performance data according to an example embodiment of the present invention;

FIG. 4 illustrates an example of performance data that may be received for a result as compared to performance data indicative of a predetermined aspirational result according to an example embodiment of the present invention;

FIG. 5 illustrates an example of environmental data that may be received according to an example embodiment of the present invention; and

FIG. 6 illustrates a flowchart of methods of correlating environmental data with performance data according to an example embodiment of the present invention.

### DETAILED DESCRIPTION

Some example embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or filmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

Human beings are creatures of habit. People have routines that they follow for various activities in an effort to achieve the best results for that activity. For example, in order to achieve the best night's sleep, one person's routine may include drinking a cup of warm milk after dinner, taking a warm bath with a certain kind of bath soap, putting on his or her favorite pajamas, reading a chapter or two from a book while sitting in bed, and then turning off the lights, while leaving the light on in the closet with the closet door cracked open by just an inch.

Despite this routine, however, the person may not be able to achieve a good night's sleep on a consistent basis. On some nights, the person may not be able to fall asleep right away. On other nights, the person may wake up two or three times in the middle of the night, seemingly without cause. Still on other nights, the person may toss and turn all night, never managing to get comfortable. Was it because he or she drank too much milk that night, or not enough? Did that person spend too much time in the bath? Did he or she read too many chapters in the book? Or were the chapters that evening too exciting? Did the sound of the rain falling gently on the skylight in the adjoining bathroom keep him or her up all night, or did it help him or her fall asleep relatively quickly, only to be awakened by a dry throat resulting from the person forgetting to turn on the humidifier?

With so many factors involved in creating the environment in which the person's activity (sleeping in this example) is to take place, it can be hard to determine which factors improve the results of the activity, which factors have a negative effect on the results, and which factors have no bearing at all. Moreover, the factors that the person believes contribute to successful results may actually have the opposite effect or may only improve the results when combined with other factors.

With advancements in technology, however, more and more objects (e.g., the devices that the person can use to create his or her environment) can be connected to a network of objects (often referred to as the Internet of Things, or IoT). Any object, for example, can be connected to this network by equipping the object with a unique identifier, such as via a radio frequency identification (RFID) tag or using other techniques that can enable the object to be managed and inventoried by a computer, including near field communication (NFC) identifiers, barcodes, Quick Response (QR) codes, digital watermarks, etc. Through such a network, data about a person's environment (e.g., air temperature, humidity level, lighting level, music being played, etc.) can be gathered and stored to provide a detailed picture of the person's environment at any given point in time. Considering the large volume of data that may be collected in this way, however, the task of sorting through the data over the course of one night (in the example above), let alone over several days or weeks, to identify trends can be daunting, if not altogether impossible.

Accordingly, example embodiments of the present invention provide mechanisms for receiving environmental data regarding the settings of various objects that may be operating in the environment of a user. In conjunction with this environmental data, performance data may also be received that describes or qualifies a result of a predefined activity. Using the example above, the activity may be sleeping; however, in other examples, the activity may be performing a certain task, such as creating a work of art, writing an article, taking an exam, etc.; engaging in a certain sport or physical activity, such as lifting weights, stretching, swinging a golf club, hitting a baseball, etc.; and so on. The performance data may be analyzed to determine whether the result of the predefined activity can be considered a predetermined aspirational result, such that the user would want to obtain the same result the next time the user performs the same activity. In the event the result is a predetermined aspirational result, embodiments of the invention may be configured to identify the object or objects that contributed to the predetermined aspirational result, such as by correlating the performance data with the environmental data to determine the relationship between the two.

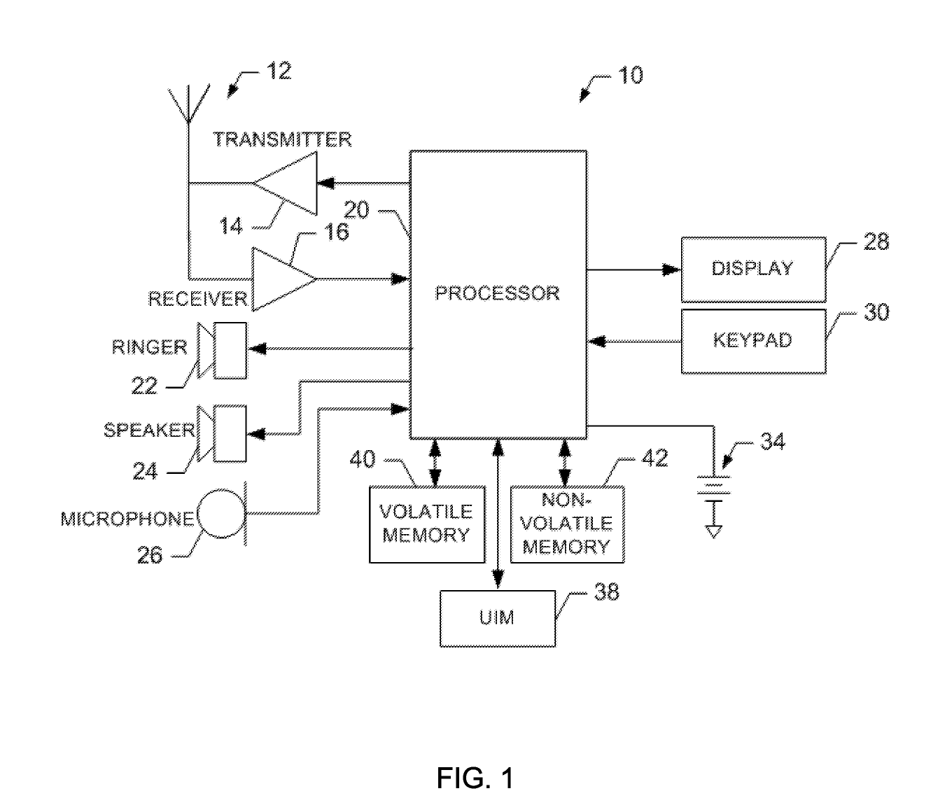

Turning now to FIG. 1, which provides one example embodiment, a block diagram of a mobile terminal 10 that would benefit from embodiments of the present invention is illustrated. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), sensors, objects, or any combination of the aforementioned, and other types of voice and text communications systems, may readily employ embodiments of the present invention, other devices including fixed (non-mobile) electronic devices may also employ some example embodiments.

As used in the description that follows, the term “object” refers to a smart object or any other physical object that is capable of communicating information to a network, such as the Internet. Such information may include data that is detected or measured by the object (e.g., temperature, humidity, acceleration, etc.), properties of the object (e.g., preferred communication protocols, a state of the object such as active or inactive, battery life, etc.), or any other data received or processed through the object. In some cases, the object may be a sensor that is configured to detect or measure a certain parameter. In other cases, the object may be a device that is accessible by the user to perform or control a certain function, such as a thermostat, a sound system, a smart phone, an actuator, etc.

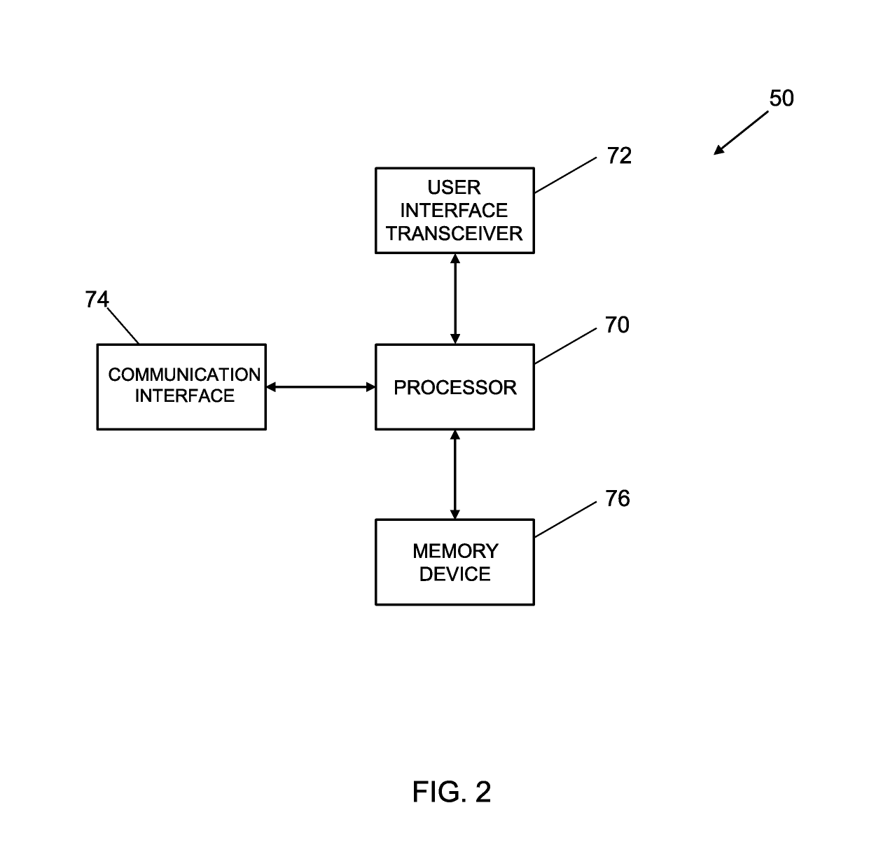

Referring again to FIG. 1, the mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

An example embodiment of the invention will now be described with reference to FIG. 2, which depicts certain elements of an apparatus 50 for correlating environmental data and performance data. The apparatus 50 of FIG. 2 may be employed, for example, with the mobile terminal 10 of FIG. 1. However, it should be noted that the apparatus 50 of FIG. 2 may also be employed in connection with a variety of other devices, both mobile and fixed, such as a server as described below, and therefore, embodiments of the present invention should not be limited to application on devices such as the mobile terminal 10 of FIG. 1. For example, the apparatus 50 may be employed on a personal computer, a tablet, a mobile telephone, or other user terminal. Moreover, in some cases, part or all of the apparatus 50 may be on a fixed device such as a server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus 50 for correlating environmental data and performance data, numerous other configurations may also be used to implement embodiments of the present invention. As such, in some embodiments, although devices or elements are shown as being in communication with each other, hereinafter such devices or elements should be considered to be capable of being embodied within a same device or element and, thus, devices or elements shown in communication should be understood to alternatively be portions of the same device or element.

Referring now to FIG. 2, the apparatus 50 for correlating environmental data and performance data may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard-coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

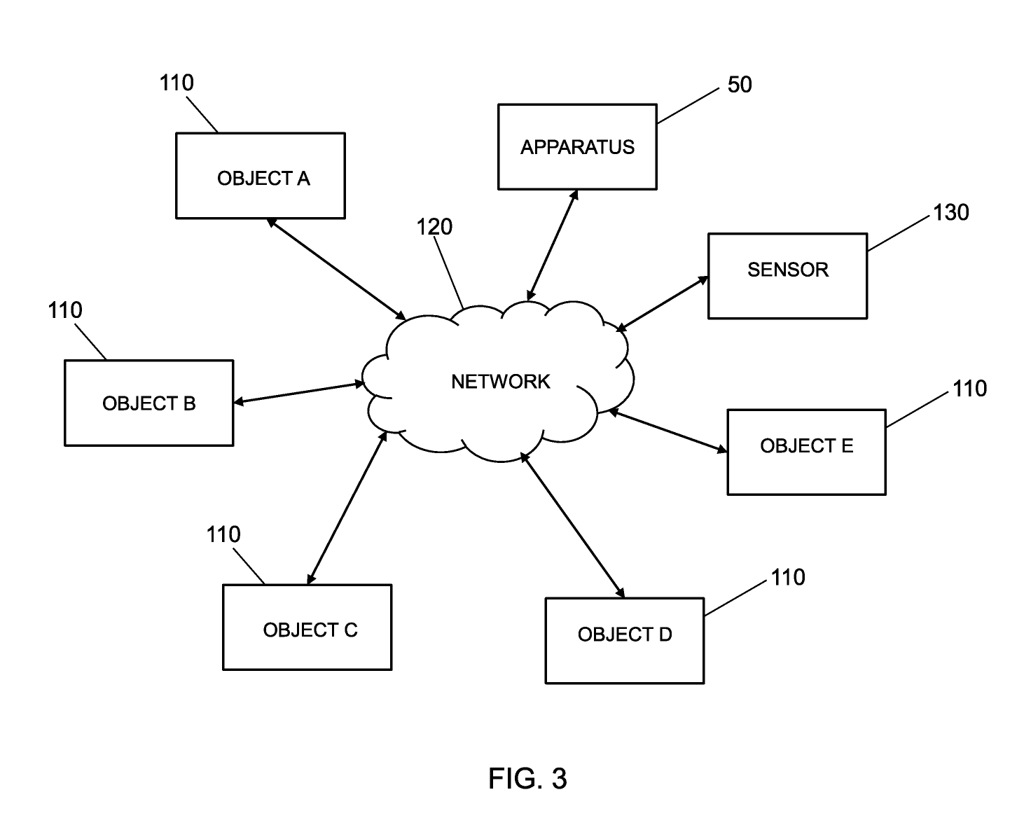

Embodiments of the invention will now be described with reference to FIG. 3. As noted above a user's environment, which may include aspects of the user's surroundings that can be experienced by the user's senses (e.g., touch, taste, smell, sight, and/or hearing), may be the result of the presence and/or operation of several objects, devices, machines, systems, and/or processes that the user has installed, configured, and/or actuated, and/or that the user simply has near him or her. For example, the user's environment when sleeping may be affected by one or more appliances, machines, etc. in the user's bedroom, such as a heating/cooling system that regulates the air temperature; a humidifier that modifies the moisture level in the air; a sound system that plays music (such as music from a playlist stored on the user's smart phone); a television that the user turns on for a period of time before going to sleep; and/or a light that the user turns on or off, among others. The user's environment when sleeping (to continue this example) may also be affected by objects that the user has near him or her, such as an article of clothing, a particular pillow, a certain blanket, etc.

With reference to FIG. 3, one or more of the appliances, machines, “things,” etc. that affect the user's environment may be considered objects 110 that are configured to communicate with an apparatus 50 (e.g., the apparatus of FIG. 2) over a network 120 according to some embodiments of the invention. For example, Object A in FIG. 3 may be the heating/cooling system in the example described above; Object B may be the humidifier; Object C may be the sound system; and Object D may be the light. Each object 110 may be configured to communicate environmental data (e.g., data regarding one or more object settings) to the apparatus 50 via the network 120. As described below, an object setting may be a value associated with the object, such as a parameter describing the operation of the object (e.g., an operational parameter describing a control parameter or operational state of the object, etc.) or an indication of the presence of the object (e.g., a proximity of the object to the user or a device associated with the user).

In this example, Object A (the heating/cooling system) may communicate environmental data that includes one or more of a temperature setting, an actual air temperature of the room, a fan speed, the operational state of the heating/cooling system (set for heating, set for cooling, on, off, etc.), and so on. Object B (the humidifier) may communicate environmental data that includes one or more of a water level in the humidifier, a humidity level in the room, the operational state of the humidifier (e.g., on or off), and so on. Object C (the sound system) may communicate environmental data that includes one or more of the operational state of the sound system (e.g., on or off), the volume level, the playlist, the source of the playlist (e.g., the user's smartphone, a CD, etc.) and so on. And Object D in this example (the light) may communicate environmental data that includes one or more of the operational state of the light (on or off), the intensity of the light, the type of light being emitted (e.g., white light, halogen, fluorescent, etc.), and so on.

In addition to the electronic devices, appliances, and machines, the user's environment may also be affected by the actions that the user takes, such as the things the user does in preparation for going to sleep. For example, the user may drink a glass of warm milk, take a warm bath, call his or her mother on the phone, etc. before getting in bed and attempting to go to sleep. These preparatory actions and/or their effects may also be monitored by objects 110, which may, for example, include electronic devices, machines, appliances, sensors, etc. that are configured to communicate with the apparatus 50 over the network 120 as shown in FIG. 3.

For example, the user's refrigerator may be configured to monitor an inventory of certain items placed therein using one or more sensors. A sensor on the refrigerator door, for example, may detect each time the door is opened; a sensor on the shelf where the milk is kept may monitor the weight (and, as a result, the amount) of milk in a jug of milk kept on that shelf; etc. Likewise, a microwave oven may include sensors that are configured to detect when the microwave is turned on, the power level, the duration of heating, etc. With respect to the warm bath the user may take, sensors on the bath tub and/or plumbing (e.g., water valves, water heater, etc.) may detect the water temperature for the bath, the water level in the bath tub, the duration of the bath, and so on. Continuing the example described above with respect to FIG. 3, Object E may be, for example, a bathtub sensor that is configured to communicate environmental data regarding object settings, where the object settings (e.g., the sensor settings) include detected parameters such as the temperature of the water and the water level over time.

As yet another example, and as mentioned above, the user's environment may also be affected by the certain “things” that the user has with him or her, such as objects connected via the IoT. These may be objects carried on the user's person, worn by the user, or simply proximate the user, such as within a predetermined distance of the user or a sensor associated with the user (e.g., the user's cellular phone). In some cases, for example, the object whose presence is to be detected may be a “smart” object that is connected to the IoT. The object may be equipped with a tag (e.g., an RFID tag) or other detectable element, and the object may be detected via communication between the tag and a sensor (e.g., a sensor on the user's smart phone). In other cases, however, the user's smart phone may be equipped with one or more cameras that are configured to capture images of the user, and the images may be analyzed (e.g., by a processor of the smart phone or a remote processor in communication with the smart phone) to identify whether a particular predetermined item (e.g., the clothing or type of clothing worn by the user, personal effects carried by the user, such as a backpack, purse, laptop bag, sweater, etc.) is near the user.

Thus, as described above, an object 110 may be a sensor that is configured to detect or measure a certain parameter, or the object may be a device, machine, appliance, or other equipment that is accessible by the user to perform or control a certain function that can affect the user's environment, or the object may be an item whose presence (e.g., proximity to the user or a device associated with the user) can be detected, etc. The object 110 may comprise a communication interface that is configured to at least transmit the information to the apparatus 50, such as via the network 120 (e.g., the Internet). As noted above, in some cases, the object 110 may be configured to transmit a particular parameter (e.g., a measured value or a control setting value, or an indication of presence), directly or indirectly, to the apparatus 50. The values may be stored, analyzed, manipulated, etc. in a memory of the apparatus 50 or a separate memory accessible to the apparatus. In other cases, however, the object 110 may include its own memory device, a processor, a user input transceiver, user input devices, etc., such as when the object is, for example, a mobile terminal such as the mobile terminal 10 shown in FIG. 1.

At the same time, one or more sensors 130 or other devices may be used to gather performance data regarding the result of a predefined activity. In the example used above, in which the activity is sleeping, for example, one or more sensors 130 may be used to measure the electrical signals produced in the user's brain, which may be indicative of whether and for how long the user is in REM sleep, light sleep, and deep sleep. Alternatively or additionally, other sensors 130 may be used to detect changes in the user's breathing patterns, such as by measuring the sound of the user's breathing, the volume of air inhaled and exhaled, the rise and fall of the user's chest, etc. Still other sensors 130 may be used to detect whether and how frequently the user gets up in the middle of the night, such as a pedometer worn on the user's body or a motion sensor in the room. Thus, the sensor 130 may be configured to detect or measure a certain parameter and may comprise a communication interface that is configured to at least transmit the detected value to the apparatus 50, such as via the network 120 (e.g., the Internet).

Accordingly, embodiments of the invention provide mechanisms for receiving environmental data and performance data (e.g., from objects 110 and sensors 130) and correlating this data to determine one or more scenarios that are expected to lead to the best results for a predefined activity. In this regard, the apparatus 50 may comprise at least one processor 70 and at least one memory 76 including computer program code, as shown in FIG. 2. The at least one memory 76 and the computer program code may be configured to, with the processor 70, cause the apparatus 50 to at least receive environmental data regarding object settings for a plurality of objects 110 and receive performance data regarding a result of a predefined activity. As noted above, an object setting may include a control parameter of the object (e.g., the thermostat setting on a heater), an operational state of the object (e.g., on or off), a detected or measured parameter (e.g., water temperature), or any other value providing information regarding an aspect of the user's environment with respect to the object. Performance data may include any information that is detected or measured and is useful for evaluating the success of a particular activity. In this regard, performance data may vary based on the particular activity being performed.

Thus, the at least one memory and the computer program code may be configured to, with the processor, cause the apparatus to determine whether the result of the predefined activity is a predetermined aspirational result based at least on the performance data that is received. In other words, embodiments of the apparatus may be caused to determine whether the user performing the activity achieved a result that can be considered a predetermined aspirational result (e.g., a desirable or optimal result). The predetermined aspirational result may be configured by the user (e.g., provided as input by the user based on the user's preferences) in some cases, or may be pre-configured or pre-programmed in the apparatus, such as based on scientific data related to the particular predefined activity, the user's own historical results with respect to the activity, etc.

For the example used above in which the activity is sleeping, the predetermined aspirational result may be described or quantified by one or more indications that the user had a good night's sleep. When the sensor 130 shown in FIG. 3 is a device (e.g., worn by the user or placed under the user's head) that monitors the electrical signals produced in the user's brain, for example, the result may be considered the predefined aspirational result when the pattern of brain waves matches or comes close to matching an “ideal” brain wave pattern indicative of “good sleep.” Such a brain wave pattern may include, for example, a cycling of brain wave patterns from Stage 1 through Stage 4 sleep.

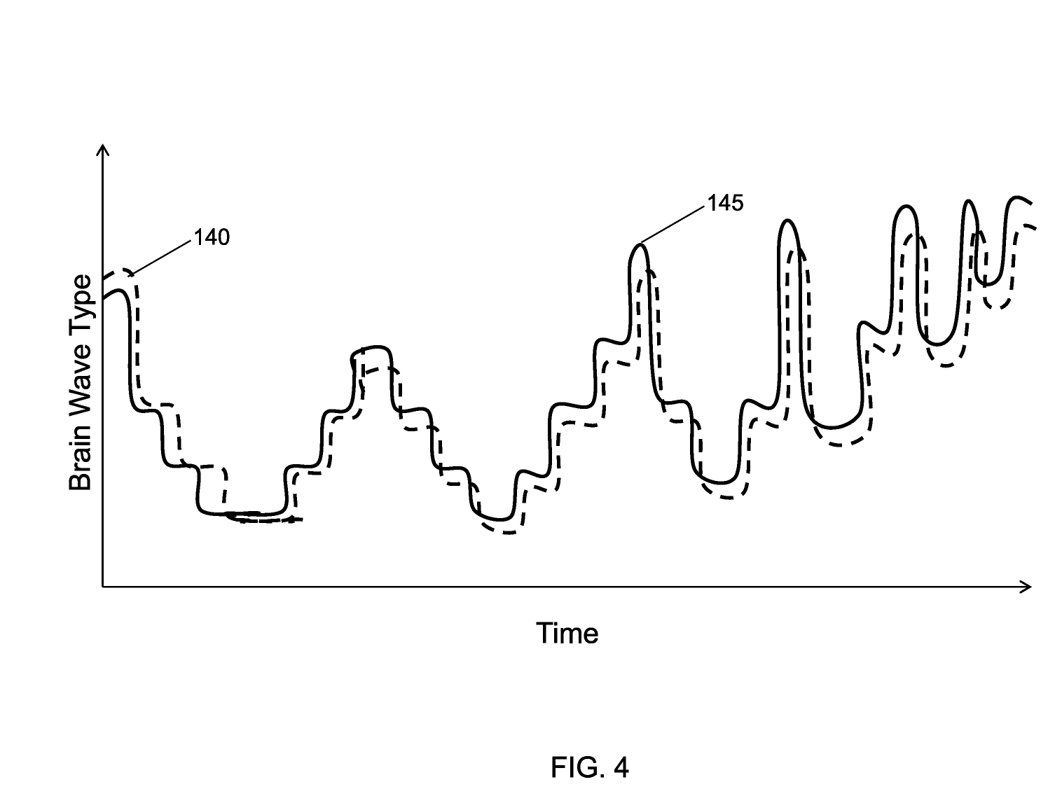

For example, according to certain scientific theories, Stage 1 may include a period of theta wave activity; Stage 2 may be a period of theta wave activity that includes periodic sleep spindles and K complexes; Stage 3 may be a period of theta wave activity that includes less than 50% delta wave activity; and Stage 4 may be a period of theta wave activity that includes more than 50% delta wave activity. A “good” night's sleep may be indicated by brain activity that demonstrates a cycling from Stage 1 sleep up to Stage 4 sleep, then back down to Stage 2, followed by a period of Rapid Eye Movement (REM) sleep, then back up to Stage 4 sleep. One cycle (from Stage 1 when the user first falls asleep to Stage 4, then back down to REM sleep) may typically take 90 minutes, and the period of delta wave activity in the stages of each subsequent cycle may decrease until there is virtually no delta sleep, indicating that the user is well-rested and ready to wake up. An example of performance data 140 received that consists of brain wave activity gathered while the user was sleeping is shown in FIG. 4 (dashed line). In comparison, a “model” brain wave pattern 145 indicative of the predefined aspirational result with respect to the activity of sleeping is also shown in FIG. 4 (solid line).

Continuing with this example in which the activity is sleep and the predefined aspirational result is demonstrated by the pattern of brain waves 145 shown in FIG. 4, the result of the user's sleep on a particular night may be determined to be the predetermined aspirational result when the performance data 140 (e.g., the pattern of brain waves detected by the sensor 130 of FIG. 3) matches or approximates (e.g., comes within a certain predefined threshold of) the “model” pattern 145 shown in FIG. 4. In some embodiments, however, the predefined aspirational result may be indicated by the user, rather than pre-configured based on scientific data as in the example above. For instance, the user, upon waking, may provide an input that is received by the apparatus indicating whether the user considers the previous night's sleep to be a restful one. In this case, the user's input would be the performance data, and the user's indication that the sleep was restful would allow the determination that the result of the predefined activity (sleep) is the predetermined aspirational result. Thus, whereas in some cases the performance data must be analyzed and compared to benchmark data that is designated as indicative of the predetermined aspirational result to determine whether the result is the predetermined aspirational result, in other cases the performance data itself includes an indication of whether or not the result is the predetermined aspirational result, without comparison to any other data.

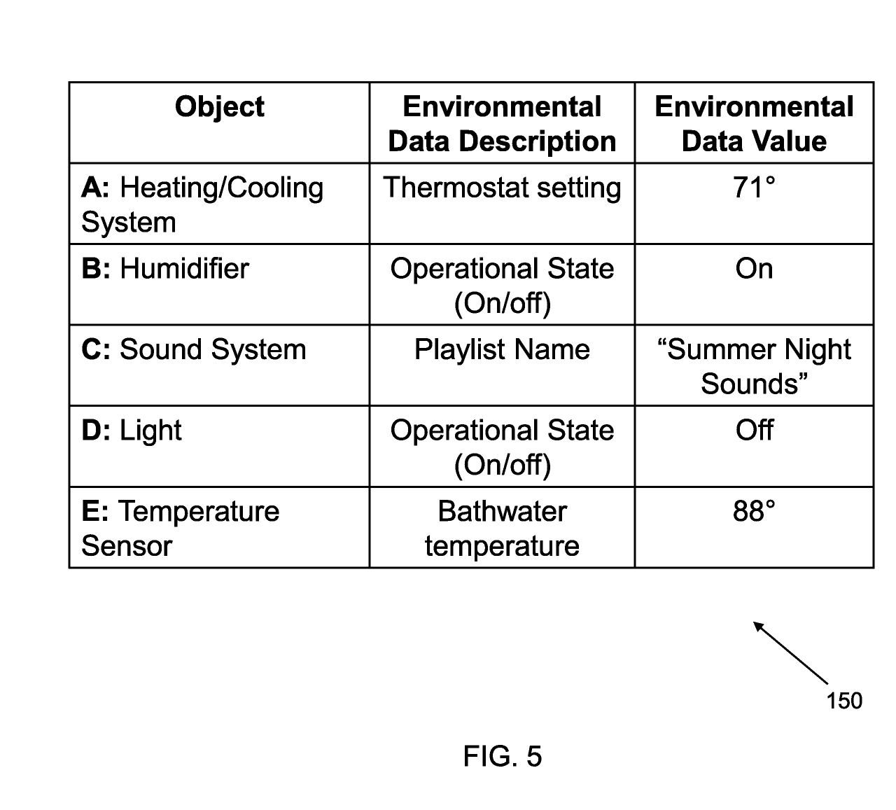

Regardless of how the determination is made, in an instance in which the result is determined to be the predetermined aspirational result, the at least one memory and the computer program code may be configured to, with the processor, cause the apparatus to identify one or more of the objects as contributing to the predetermined aspirational result based at least on the environmental data received. With reference to FIGS. 3 and 5, for example, in the scenario described above in which the activity is sleep and the predetermined aspirational result (a good night's sleep) has been achieved, environmental data 150 may have been received regarding object settings for a heating/cooling system (Object A), a humidifier (Object B), a sound system (Object C), a light (Object D), and a bathwater temperature sensor (Object E). For ease of explanation, in this example, each object 110 is configured to provide only one piece of environmental data 150 that is received by the apparatus, as described in FIG. 5. In other cases, however, an object may be capable of providing more than one piece of environmental data (e.g., multiple settings or readings, such as an air temperature setting, fan speed, and actual air temperature in the case of the heating/cooling system). Moreover, although the example depicted in FIG. 5 shows environmental data 150 at only one point in time, which may not be common across all of the objects, depending on the sophistication of the system, the particular activity being evaluated, the user's preferences, etc., environmental data may be received from each object at predefined intervals, such as once every five minutes or once every 30 minutes.

In the example of FIG. 5, the user got a good night's sleep (the predetermined aspirational result) when the heating/cooling system was set at 71° F., the humidifier was turned on, the sound system was playing “Summer Night Sounds” (a soundtrack of peaceful sounds one might hear on a summer night), the light in the room was turned off, and the bathwater used for his or her pre-bedtime bath was a comfortably warm 88° F. Therefore, in this example, the apparatus may be caused to identify that Object A (the heating/cooling system), Object B (the humidifier), Object C (the sound system), and Object E (the temperature sensor) contributed to the achieving a good night's sleep, whereas Object D (the light) was unnecessary. From this information, the user may learn that to get a good night's sleep he or she needs to have a heating/cooling system, a humidifier, and a sound system, and that a warm bath before bedtime is also helpful.

In many cases, however, even more helpful than knowing that he or she needs a heating/cooling system (which most people have to regulate the temperature inside their living quarters anyway) is knowing at what temperature to set the heating/cooling system. Thus, in some embodiments, in an instance in which the result is the predetermined aspirational result, the at least one memory and the computer program code may be configured to, with the processor, cause the apparatus to determine the object setting for at least one of the objects identified based at least on the environmental data. For example, based on the environmental data 150 received, the apparatus may be caused to determine that the heating/cooling system (Object A) must be set to a temperature of 71° F. to achieve the predetermined aspirational result of a good night's sleep. Furthermore, in still other embodiments, the at least one memory and the computer program code may be configured to, with the processor, cause the apparatus to cause at least one of the objects identified to be set at the respective object setting that was determined. Thus, in the previous example, the apparatus may be configured such that it is further capable of communicating the determined optimal setting of 71° F. to the heating/cooling system and directing the heating/cooling system to be set at this value.

In some embodiments, the at least one memory and the computer program code may be configured to, with the processor, cause the apparatus to provide for storage of the environmental data and the performance data received and to determine a relationship between the object settings and the result of the predefined activity based on analysis of the environmental data and the performance data over a period of time. For example, in the sleep scenario described above, environmental data such as the environmental data 150 shown in FIG. 5 may be collected and stored each night for a series of nights, such as for one month. In addition, performance data such as the performance data 140 shown in FIG. 3 may be collected and stored for each of those same nights. By analyzing the environmental data and the performance data over time, such as over the course of the month for which the data is saved, the apparatus may determine a relationship between the two sets of data. For example, the apparatus may determine that as the temperature at which the heating/cooling system (Object A) approaches 75° F. (from the environmental data), the user experiences a deeper sleep (from the performance data) and that if the bathwater temperature drops below 80° F., it takes the user a longer time to fall asleep. At the same time, the apparatus may determine that turning on the humidifier (Object B) allows the user to wake up fewer times during the night and that the user's choice of soundtrack does not affect the user's sleep, but that the absence of a soundtrack altogether causes the user not to sleep as well. The relationships that may be determined by the apparatus based on an analysis of the environmental data and the performance data may be much more complex than those used in the example above and may take into account the length of time over which the data is stored, the number of data points, differences in the objects and combinations of objects over that time, and user preferences for the analysis. In this regard, the user may be able to provide input as to how the data should be analyzed, such as by indicating the time period for the analysis, which objects should be considered, etc.

By conducting such analyses, and based on the relationship determined, in some embodiments, the at least one memory and the computer program code may be configured to, with the processor, cause the apparatus to determine a future setting of at least one of the objects in an attempt to achieve the predetermined aspirational result, such as in an instance in which the result of the activity is not determined to be the predetermined aspirational result. Using the sleep example above, if the user did not get a good night's sleep the previous night, but has in the past achieved the aspirational result of a good night's sleep, the apparatus may be able to use the analysis of the user's historical environmental data and performance data to determine how one or more of the objects should be set the following night to try to achieve a good night's sleep. This may involve, for example, projections regarding how modifying certain settings in the environmental data may affect the performance data (e.g., using extrapolations and statistical analysis, etc.).

Moreover, the at least one memory and the computer program code may be configured to, with the processor, cause the apparatus to provide for adjustment of a setting of the at least one of the objects to the setting determined through this analysis, such as over the course of one or more attempts to achieve the predetermined aspirational result. In this way, the apparatus may be able to direct a trial-and-error approach to achieving the predetermined aspirational result, even in a case in which the user has not yet been able to achieve this result on his or her own.

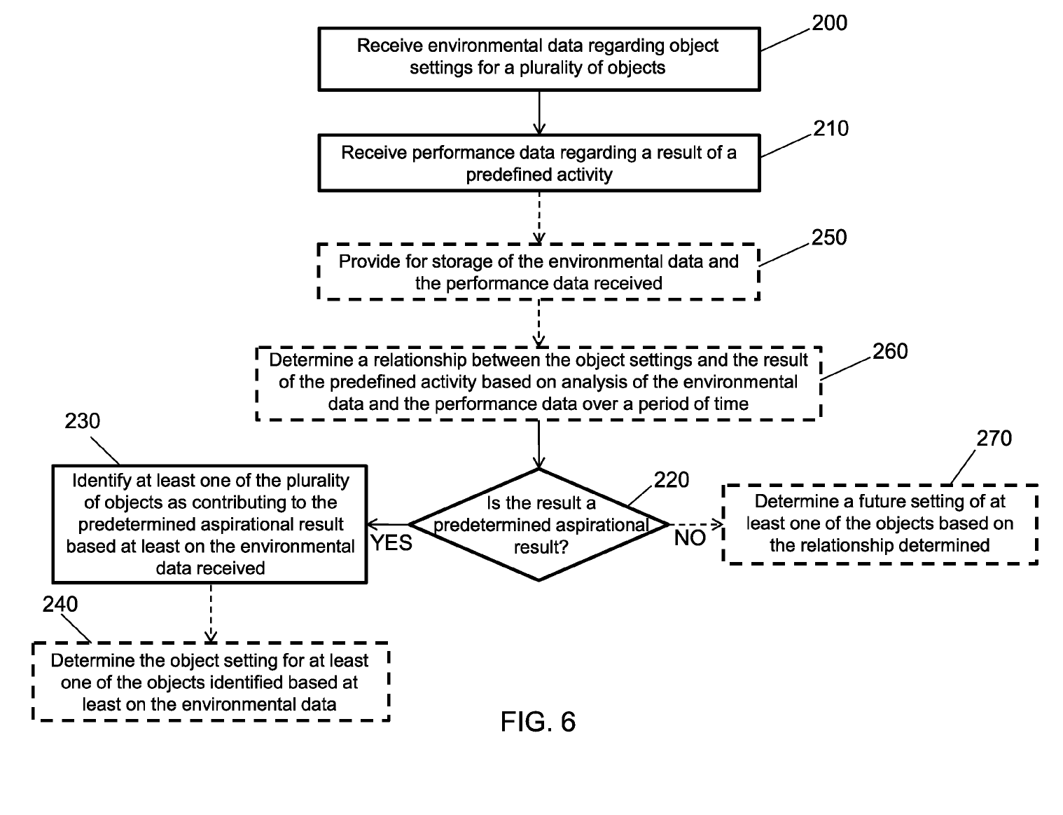

FIG. 6 illustrates a flowchart of systems, methods, and computer program products according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an example embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one example embodiment of a method for correlating environmental data with performance data is shown in FIG. 6. FIG. 6 depicts an example embodiment of the method that includes receiving environmental data regarding object settings for a plurality of objects at block 200 and receiving performance data regarding a result of a predefined activity at block 210. A determination may be made at block 220 as to whether the result is a predetermined aspirational result based at least on the performance data received, as described above. As described above, the performance data may be received from at least one performance sensor. If the result is the predetermined aspirational result, at least one of the plurality of objects may be identified at block 230 as contributing to the predetermined aspirational result based at least on the environmental data received.

In some cases, in an instance in which the result is the predetermined aspirational result, the object setting for at least one of the objects identified may be determined at block 240 based at least on the environmental data. Moreover, the at least one object identified may be set at the respective object setting that is determined (e.g., automatically and/or without user intervention).

In some embodiments, the environmental data and the performance data that is received may be stored at block 250, and a relationship between the object settings and the result of the predefined activity may be determined at block 260 based on analysis of the environmental data and the performance data over a period of time. In an instance in which the result is not the predetermined aspirational result, a future setting of at least one of the objects may be determined at block 270 based on the relationship determined at block 260 in an attempt to achieve the predetermined aspirational result, as described above. For example, a setting of the at least one of the objects may be adjusted to the setting that is determined.

In some embodiments, certain ones of the operations above may be modified or further amplified as described below. Furthermore, in some embodiments, additional optional operations may be included, some examples of which are shown in dashed lines in FIG. 6. Although the operations above are shown in a certain order in FIG. 6, certain operations may be performed in any order. In addition, modifications, additions, or amplifications to the operations above may be performed in any order and in any combination.

In an example embodiment, an apparatus for performing the methods of FIG. 6 above may comprise a processor (e.g., the processor 70 of FIG. 2) configured to perform some or each of the operations (200-270) described above. The processor may, for example, be configured to perform the operations (200-270) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200 and 270 may comprise, for example, the communication interface 74, the processor 70, and/or a device or circuit for executing instructions or executing an algorithm for processing information as described above. Examples of means for performing operation 210 may comprise, for example, the user interface transceiver 72, the processor 70, the communication interface 74, and/or a device or circuit for executing instructions or executing an algorithm for processing information as described above. Examples of means for performing operations 220, 230, 240, and 260 may comprise, for example, the memory device 76, the processor 70, and/or a device or circuit for executing instructions or executing an algorithm for processing information as described above. Examples of means for performing operation 250 may comprise, for example, the memory device 76, the processor 70, the communication interface 74, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, although the depicted embodiments are explained in a context in which the user activity is sleeping and the predetermined aspirational result is a good night's sleep, it is understood that various different user activities may benefit from embodiments of the present invention. Moreover, although the objects and the respective environmental data is simplified as described above with respect to the example and figures provided, it is understood that the objects, object settings, etc. may be much more complex and may take into account multiple object settings for each object, for example. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-29. (canceled)

30. An apparatus comprising at least one processor and at least one memory including computer program code, the at least one memory and the computer program code configured to, with the processor, cause the apparatus to at least:
receive environmental data regarding object settings for a plurality of objects, wherein the object settings comprise one or more of an operational state of an object and an indication of presence of the object;
receive performance data regarding a result of a predefined activity;
determine whether the result is a predetermined aspirational result based at least on the performance data received; and
in an instance in which the result is the predetermined aspirational result, identify at least one of the plurality of objects as contributing to the predetermined aspirational result based at least on the environmental data received.

31. The apparatus of claim 30, wherein, in an instance in which the result is the predetermined aspirational result, the at least one memory and the computer program code are configured to, with the processor, cause the apparatus to determine the object setting for at least one of the objects identified based at least on the environmental data.

32. The apparatus of claim 31, wherein the at least one memory and the computer program code are configured to, with the processor, cause the apparatus to cause the at least one object identified to be set at the respective object setting determined.

33. The apparatus of claim 30, wherein the at least one memory and the computer program code are configured to, with the processor, cause the apparatus to provide for storage of the environmental data and the performance data received and to determine a relationship between the object settings and the result of the predefined activity based on analysis of the environmental data and the performance data over a period of time.

34. The apparatus of claim 33, wherein, in an instance in which the result is not the predetermined aspirational result, the at least one memory and the computer program code are configured to, with the processor, cause the apparatus to determine a future setting of at least one of the objects based on the relationship determined in an attempt to achieve the predetermined aspirational result.

35. The apparatus of claim 34, wherein the at least one memory and the computer program code are configured to, with the processor, cause the apparatus to provide for adjustment of a setting of the at least one of the objects to the setting determined.

36. The apparatus of claim 30, wherein the performance data is received from at least one performance sensor.

37. The apparatus of claim 30, wherein the object settings comprise an operational state of an object or an indication of presence of the object.

38. A method comprising:
receiving environmental data regarding object settings for a plurality of objects, wherein the object settings comprise one or more of an operational state of an object and an indication of presence of the object;
receiving performance data regarding a result of a predefined activity;
determining whether the result is a predetermined aspirational result based at least on the performance data received; and
in an instance in which the result is the predetermined aspirational result, identifying at least one of the plurality of objects as contributing to the predetermined aspirational result based at least on the environmental data received.

39. The method of claim 38, wherein, in an instance in which the result is the predetermined aspirational result, the method further comprises determining the object setting for at least one of the objects identified based at least on the environmental data.

40. The method of claim 39 further comprising causing the at least one object identified to be set at the respective object setting determined.

41. The method of claim 38, further comprising providing for storage of the environmental data and the performance data received and determining a relationship between the object settings and the result of the predefined activity based on analysis of the environmental data and the performance data over a period of time.

42. The method of claim 41, wherein, in an instance in which the result is not the predetermined aspirational result, the method further comprises determining a future setting of at least one of the objects based on the relationship determined in an attempt to achieve the predetermined aspirational result.

43. The method of claim 42, further comprising providing for adjustment of a setting of the at least one of the objects to the setting determined.

44. The method of claim 38, wherein the performance data is received from at least one performance sensor.

45. The method of claim 38, wherein the object settings comprise an operational state of an object or an indication of presence of the object.

46. A computer program product comprising at least one computer-readable storage medium having computer-executable program code portions stored therein, the computer-executable program code portions comprising program code instructions for:
receiving environmental data regarding object settings for a plurality of objects, wherein the object settings comprise one or more of an operational state of an object and an indication of presence of the object;
receiving performance data regarding a result of a predefined activity;
determining whether the result is a predetermined aspirational result based at least on the performance data received; and
in an instance in which the result is the predetermined aspirational result, identifying at least one of the plurality of objects as contributing to the predetermined aspirational result based at least on the environmental data received.

47. The computer program product of claim 46, wherein, in an instance in which the result is the predetermined aspirational result, the computer program product further comprises program code instructions for determining the object setting for at least one of the objects identified based at least on the environmental data.

48. The computer program product of claim 47, further comprising program code instructions for causing the at least one object identified to be set at the respective object setting determined.

49. The computer program product of claim 47, further comprising program code instructions for providing for storage of the environmental data and the performance data received and determining a relationship between the object settings and the result of the predefined activity based on analysis of the environmental data and the performance data over a period of time.
